(19) United States
(12) Patent Application Publication
(10) Pub. No.: US 2017/0061821 A1
(43) Pub. Date: Mar. 2, 2017

(54) Systems and methods for performing a food tracking service for tracking consumption of food items

(71) Applicants: ELIZABETH EUN-YOUNG CHOI, TORONTO (CA); JEFFREY EARNEST ALFONSI, TORONTO (CA)

(72) Inventors: ELIZABETH EUN-YOUNG CHOI, TORONTO (CA); JEFFREY EARNEST ALFONSI, TORONTO (CA)

(21) Appl. No.: 15/099,281

(22) Filed: Apr. 14, 2016

Related U.S. Application Data
(63) Continuation of application No. 62/213,324, filed on Sep. 2, 2015.

(51) Int. Cl. G09B 19/00; G06F 21/31; G06K 9/62; G06T 7/60; G09B 5/02; G06K 9/00

(52) U.S. Cl. CPC G09B 19/0092; G09B 5/02; G06K 9/00671; G06K 9/6215; G06T 7/602; G06F 21/31; G06T 2207/10028; G06T 2207/30128

(57) ABSTRACT

Systems and methods are provided for performing a food tracking service for tracking consumption of one or more food items. The method comprises receiving an authentication request from a user device wherein the request includes user credentials provided by a user through a graphical user interface on the user device that receives input from the user. The authentication request is processed to determine if the user is a registered user authorized to access the food tracking service. A food input means obtain an indicator of one or more food items to be consumed and the indicator is processed to extract a string of food parameters. The food parameters are processed to identify the one or more food items associated with the food parameters and its corresponding nutritional information. The one or more identified food items and corresponding nutritional information are then transmitted to the user device.

### CROSS-REFERENCE TO RELATED APPLICATIONS

The present application claims priority from U.S. Provisional Patent Application No. 62/213,324 filed on Sep. 2, 2015 entitled “A method of managing food consumption for patients with chronic diseases”. The contents of the referenced provisional application is incorporated by reference.

### BACKGROUND OF THE INVENTION

The present invention relates to the field of managing food consumption through diet management.

One of the most important methods for addressing the growing problem of obesity is monitoring a person's calorie intake. Determining the actual amount of calories consumed by a user is advantageous for people trying to lose weight or adhere to strict dietary needs. However, monitoring and measuring food consumption continues to be a challenge since people are generally not aware of the nutritional information associated with food items they consume.

Smart wearable device and corresponding food consumption logging software technology are known in the art. Recent advances in smart wearable device technology includes wearable sensors that measure heart rate, blood pressure, temperature and other physiological parameters. Smart wearable device interfaces are currently limited in the way they are able to obtain input from the user.

Current food logging mechanisms require manual entry of consumption and nutrition information for each meal. Manual entry of every food item consumed requires accuracy of the caloric count and consistency of logging to be effective. For example, current food logging technique includes the use of a mobile phone application with a menu-driven interface that helps a person enter information concerning the food that they consume. However, users often forget to log their intake or mistakenly provide an inaccurate caloric count resulting in misleading results.

There is a need for a better method for automatically determining what food items the user has consumed and for monitoring the user's caloric intake.

### SUMMARY OF THE INVENTION

A method is provided for tracking consumption of one or more food items. The method comprises receiving an authentication request from a user device wherein the request includes user credentials provided by a user through a graphical user interface that receives input from the user and displays output. The authentication request is processed to determine if the user is a registered user authorized to access the food tracking service. A food input means obtain an indicator of one or more food items to be consumed and the indicator is processed to extract a string of food parameters. The food parameters are processed to identify the one or more food items associated with the food parameters and its corresponding nutritional information. The one or more identified food items and corresponding nutritional information are then transmitted to the user device to be displayed to the user.

A method is also provided for tracking consumption of one or more food items. The method comprises transmitting authentication credentials to a remote source to determine whether the user is a registered user authorized to access the food tracking service. An indicator of a food item is then produced wherein the indicator comprises one or more photos of the one or more food items to be consumed and wherein the food item is either a complex food item or a simple food item. The indicator is then transmitted to a remote source wherein the remote source is able to determine whether the food item is a simple food item or a complex food item and if the food item is a complex food item then the remote source identifies all the simple food items composed in the complex food item. A calculated sum of nutrient value for the food item is then produced and displayed.

A system is also provided for monitoring food consumption. The system comprises a food input means running on a user device that obtains an indicator of the one or more food items to be consumed and a processing unit for extracting a string of food parameters from the indicator and analyzing the parameters to identify one or more food items associated with the food parameters and estimate the types and amounts of food, ingredients, nutrients and calories that are associated with the one or more food items.

Further aspects of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings, wherein:

FIG. 1 is an exemplary environment in which a food consumption management system may be used;

FIG. 2 is a block diagram illustrating an exemplary implementation of the user device of FIG. 1;

FIG. 3 is a schematic illustration of an exemplary implementation of a data structure of the database of FIG. 1;

FIG. 4 is a flow chart illustrating one example process for tracking the amount of food nutrients consumed by a user;

FIG. 5 is a schematic illustration of an exemplary implementation of processing simple food items;

FIG. 6 is a schematic illustration of an exemplary implementation of processing complex food items; and

FIG. 7 is a schematic illustration of an exemplary implementation of obtaining refined input of food item from the user;

FIG. 8 is a schematic illustration of an exemplary implementation of an authentication display to obtain credentials from the user;

FIG. 9 is a schematic illustration of an exemplary implementation of the food input means;

FIG. 10 is a schematic illustration of an exemplary implementation of an image indicator of the food item obtained by the food input means;

FIG. 11 is a schematic illustration of an exemplary implementation of a visual display that allows the user to guess the nutritional value of the food item obtained by the food input means;

FIG. 12 is a schematic illustration of an exemplary implementation of a visual display of the nutritional value of the food item; and

FIG. 13 is a schematic illustration of an exemplary implementation of a visual display of the nutritional value of the food item;

### DETAILED DESCRIPTION OF THE INVENTION

While the invention has been shown and described with reference to a particular embodiment thereof, it will be understood to those skilled in the art, that various changes in form and details may be made therein without departing from the spirit and scope of the invention.

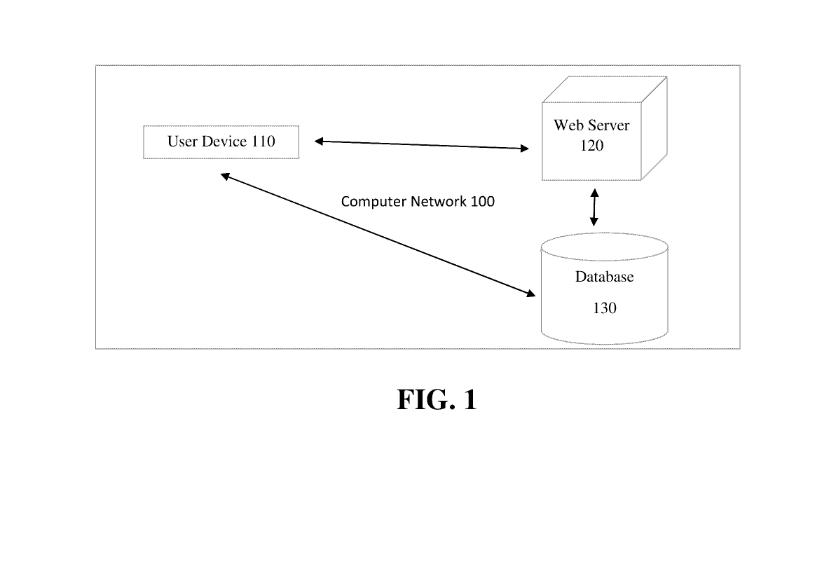

FIG. 1 is a diagram illustrating an exemplary computer network 100 in which systems and methods described herein may be implemented. Computer network 100 may include one or more user devices 110, web server 120 and a database 130.

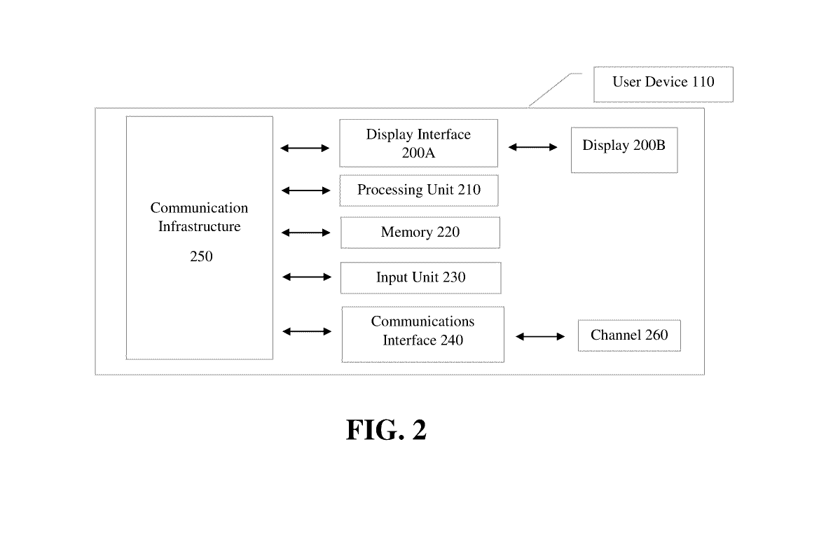

User device 110 may include a mobile device or a stationary device that is capable of executing one or more applications. For example, user device 110 may include a smart phone, a personal computer, a laptop computer or a tablet computer. FIG. 2 is a block diagram of a user device 110. User device includes a display interface 200A that forwards graphics, text and other data from the communication infrastructure received from a remote server such as a web server 120 or database 130 for display on the display 200B. The display 200B may be provided by one or more HyperText Markup Language (HTML) or HyperText Markup Language 5 (HTML5) pages transmitted from a web server 120. HTML and HTML5 pages are rendered using browser controls available in the user device's operating systems. Alternatively, the display 200B may be provided by a mobile application installed on the user device 110 that communicates with a remote server. The mobile application is executed on top of a mobile operating system such as Apple's iOS, Google Android, and other operating systems.

User device 110 may also include a processing unit 210, a memory 220, an input unit 230, and a communications interface 240. Processing unit 210 may include one or more processors or microprocessors that interpret and execute instructions. The processing unit is connected to a communication infrastructure 250 (e.g. a communications bus or network). Memory 220 includes a random access memory (RAM) or read only memory (ROM) or any other type of dynamic storage device that stores information for execution by the processing unit 210. Communications interface 250 allows software data to be transferred between the user device and external devices. Software and data transferred via communications interface 250 are in the form of signals which may be capable of being received by communications interface. These signals are provided to communications interface via a channel 260. The channel 260 carries signals and may be implemented using wire, a cellular link, radio frequency link and other communication means.

Web server 120 may include one or more network devices or computing devices that receive and store user device information from the user devices 110. Database 130 stores data that the web server 120 receives from user device 110. The database 130 may be a distributed component. Network 100 may include a wireless communications network that connects the user devices 110 to a web server 120. The network may include a long-term evolution (LTE) network, a WiFi network (IEEE 802.11 standards) or other access networks.

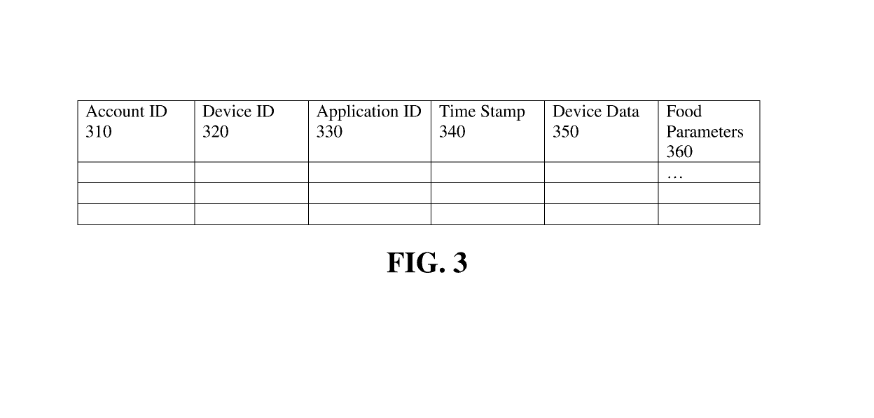

FIG. 3 is a diagram of an example data structure 300 that may correspond to database 130. The data structure 300 may include an account ID field 310, a device ID field 320, an application ID field 330, a time stamp field 340, a device data field 350 and a variety of entries 360 associated with fields 310-350 along with food parameters associated with food items. Examples of such entries include: Water; Energy; Protein; Total lipid (fat); Ash; Carbohydrate; Fiber, total dietary; Sugars, total; Sucrose; Glucose (dextrose); Fructose; Lactose; Maltose; Galactose; Starch; Calcium, Ca; Iron, Fe; Magnesium, Mg; Phosphorus, P; Potassium, K; Sodium, Na; Zinc, Zn; Copper, Cu; Manganese, Mn; Selenium, Se; Fluoride, F; Vitamin C, total ascorbic acid; Thiamin; Riboflavin; Niacin; Pantothenic acid; Vitamin B6; Folate, total; Folic acid; Folate, food; Folate, DFE; Choline, total; Betaine; Vitamin B12; Vitamin B12, added; Vitamin A, RAE; Retinol; Carotene, beta; Carotene, alpha; Cryptoxanthin, beta; Vitamin A, IU; Lycopene; Lutein+zeaxanthin; Vitamin E (alphatocopherol); Vitamin E, added; Tocopherol, beta; Tocopherol, gamma; Tocopherol, delta; Tocotrienol, alpha; Tocotrienol, beta; Tocotrienol, gamma; Tocotrienol, delta; Vitamin D (D2+D3); Vitamin D2 (ergocalciferol); Vitamin D3 (cholecalciferol); Vitamin D; Vitamin K (phylloquinone); Dihydrophylloquinone; Menaquinone-4; Fatty acids, total saturated; Fatty acids, Cholesterol; Phytosterols; Stigmasterol; Campesterol; Beta-sitosterol; Tryptophan; Threonine; Isoleucine; Leucine; Lysine; Methionine; Cystine; Phenylalanine; Tyrosine; Valine; Arginine; Histidine; Alanine; Aspartic acid; Glutamic acid; Glycine; Proline; Serine; Hydroxyproline; Alcohol, ethyl; Caffeine; Theobromine;

The Account ID field 310 may include an alpha-numeric strict associated with the user. The Device ID field 320 may include a unique identifier for user device 110. The device ID may correspond to a media access control (MAC) address or an original alpha-numeric string that uniquely identifies a particular user device 110.

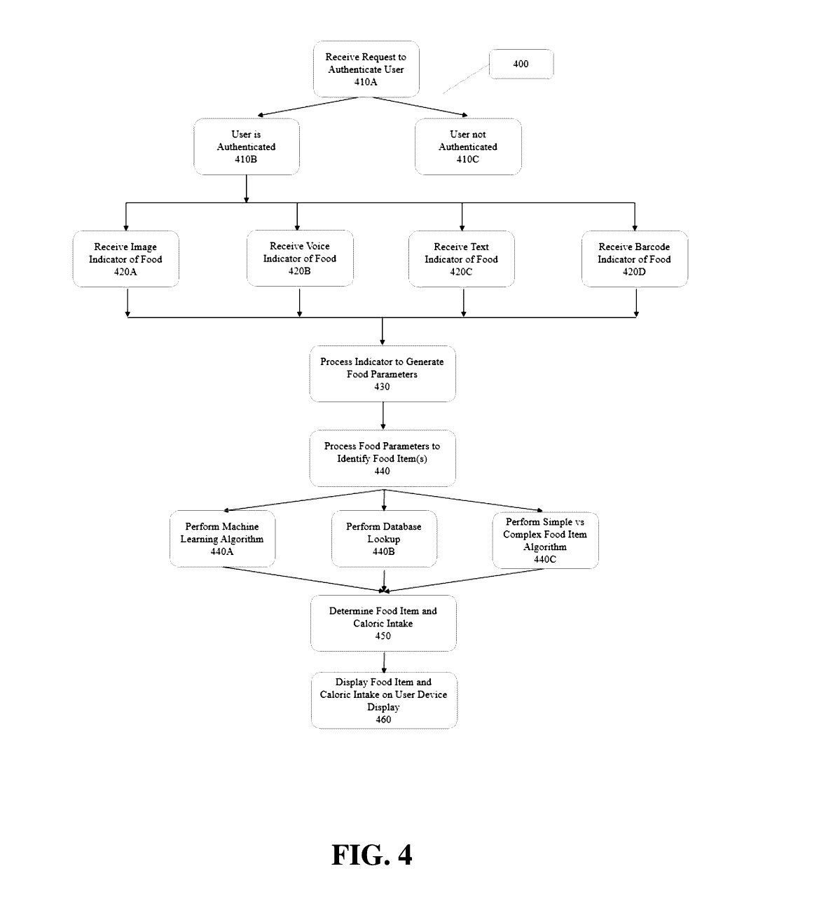

FIG. 4 is a flow diagram illustrating an exemplary process 400 for providing a method of a food tracking service. The service may track the amount of food, ingredient or nutrient consumed by a user and may also provide feedback to the user based on the user's cumulative consumption relative to a target amount. In one implementation, process 400 may be initiated on a web browser on the user device whereby the user provides a Uniform Resource Locator (URL) into the web browser and retrieves web pages from the web server 120. The subsequent steps of the process 400 may be performed by a combination of the user device 110 and web server 120 as the user device 110 and web server 120 communicate according to well-known client-server protocols. The web server may provide content to the user device in encrypted format whereby the user device must use a decryption key to decrypt the encrypted content. In another implementation, the process 400 may be performed by a mobile application running on the user device 110.

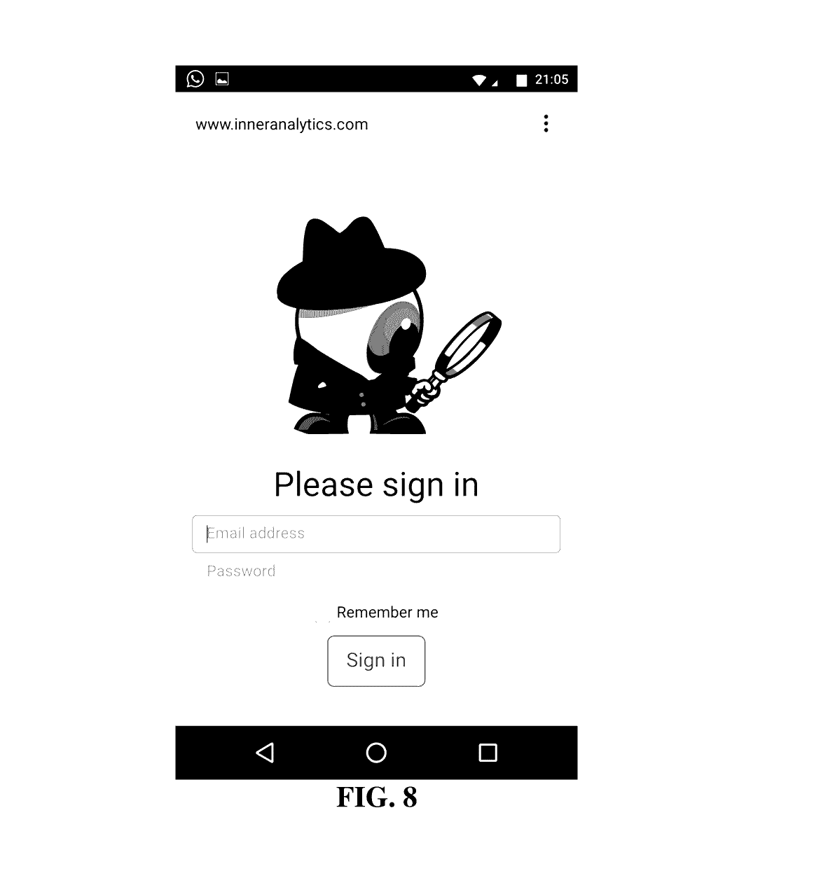

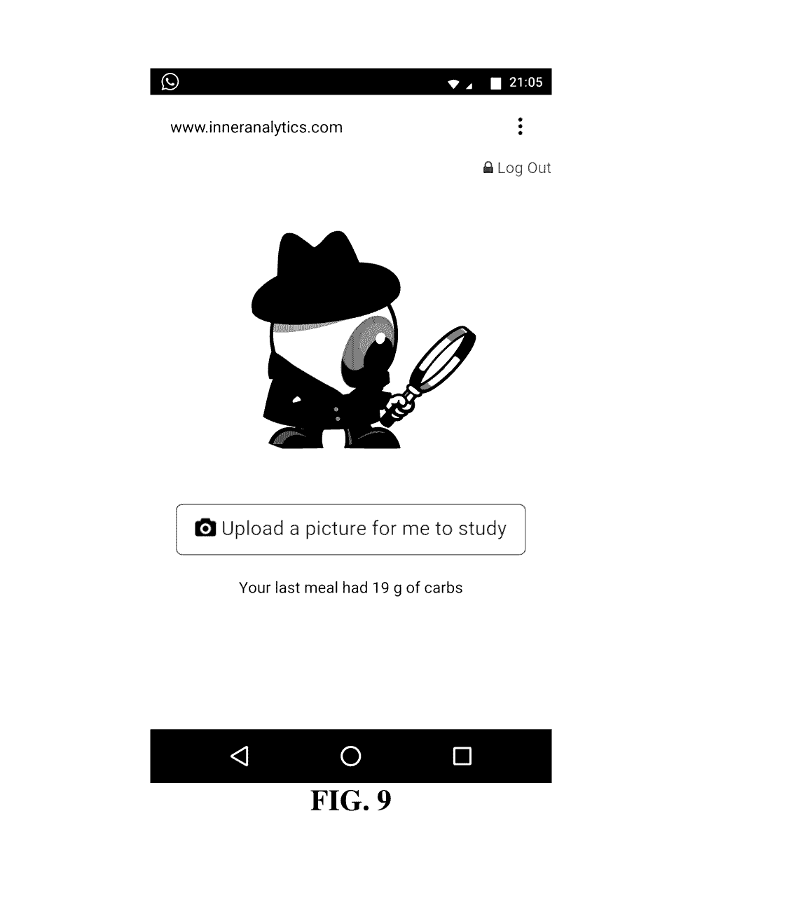

At 410A, the process 400 receives an authentication request comprising user credentials such as a username and password from a user device 110 to determine if the user of the user device is registered and authenticated to the food tracking service. FIG. 8 is an exemplary authentication display at the user device. At 410B, if the user is registered and authenticated then the user's profile is retrieved and a food input means can be initiated. FIG. 9 is an exemplary display at the user device of the food input means. At 410C, if the user is not registered or authenticated then the user device receives a prompt requesting the user to re-enter their user credentials or register with the food tracking service.

The food input means obtains an indicator of the food to be consumed from the user of the user device. The indicator is a descriptor that may be in the form of an image, voice, text or barcode.

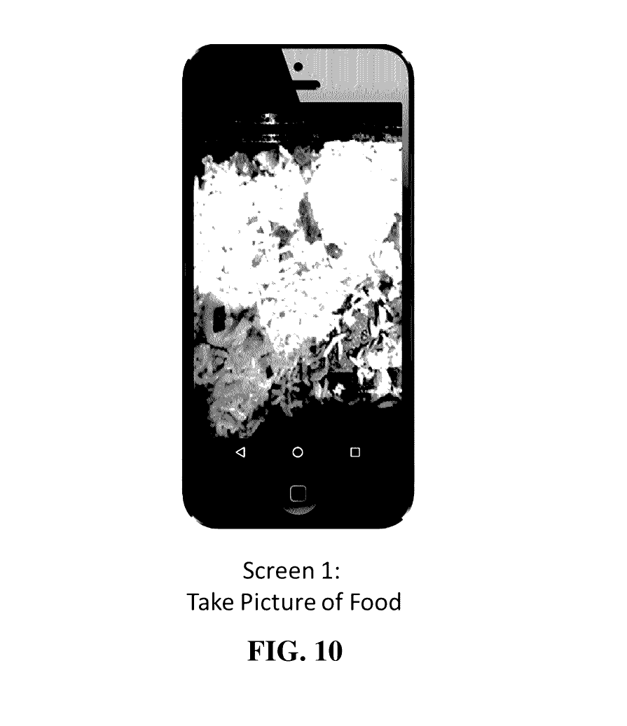

In one embodiment, the food input means is an image taking application associated with the mobile device's camera. At 420A, the food items are detected in the field of view of the camera. FIG. 10 is an exemplary display of the user device of a detected food item. A camera that is used for monitoring food consumption and/or identifying consumption of specific foods may be a part of the user device 110. The camera that is used for identifying food consumption can have a variable focal length and be automatically adjusted to focus on the food.

In an alternative embodiment, the food input means is a voice receiving application associated with the user device's microphone. At 420B, the user verbally describes into the microphone associated with the voice receiving application, the food they are about to consume. The microphone that is used for receiving the verbal description may be part of the user device 110.

In an alternative embodiment, the food input means may receive a textual description of the food from the user device. At 420C, the user of the user device provides textual description of the food to be consumed. The textual description may be a specific food item selected by the user where the description is one or more of a plurality of pre-populated food items. The pre-populated food items may include food items from the menu of popular restaurants and fast food chains to allow the user to more easily describe the food. The pre-populated food items may be retrieved from a remote database or server. The user device may also provide an interface that allows the user to manually enter their own description or refine the textual description such as specifying portions and weight.

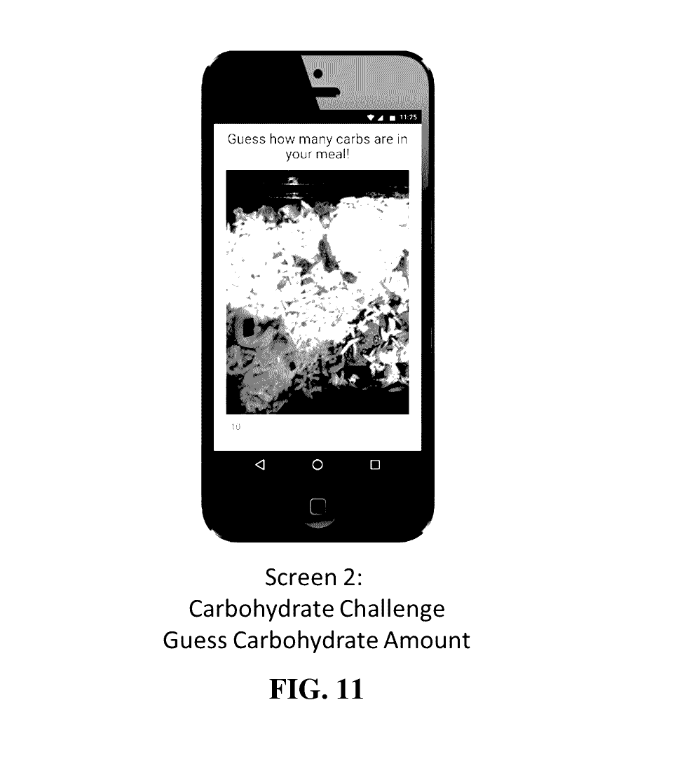

The user device may also allow the user to guess the nutritional value of the food item as illustrated in FIG. 11. The process can subsequently provide feedback that illustrates how close the user's guess is to the actual nutritional value of the food item. The guess functionality provides a number of key benefits such as health management, education and gamification. As a health management mechanism, this feature is used to assist the user in managing their health related issue(s) through diet. An alert will populate on the interface if the user's guess is above a certain threshold of difference from the actual nutritional value of the food item.

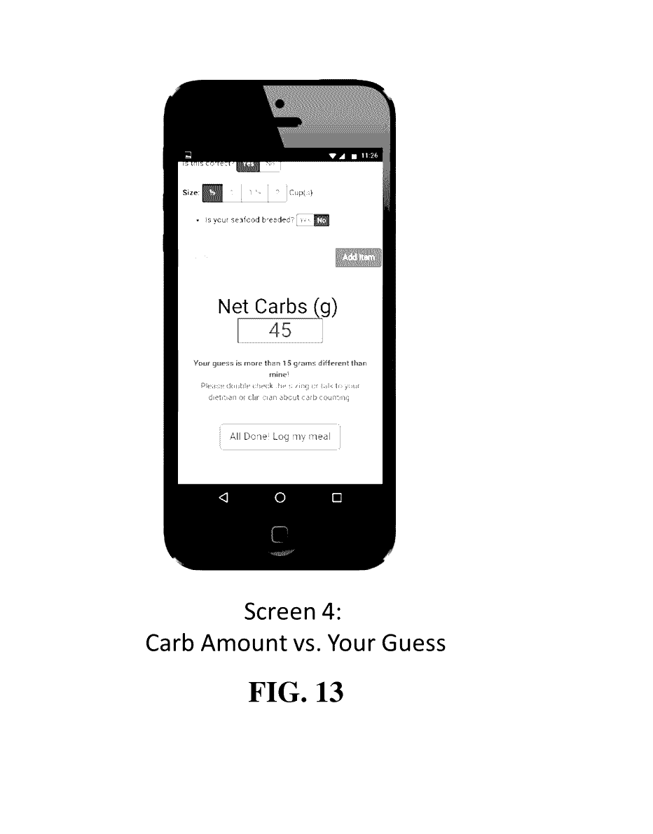

As illustrated in FIG. 13, an exemplary user is a diabetic patient utilizing a user device to determine the amount of net carbohydrates (carbohydrates—fiber) in the food item. The user will likely rely on this output to determine the dose of insulin required in order to consume the food item while managing their disease. For example, if the user's guess is 10 g of net carbohydrates and the actual net carbohydrate value is 45 g, resulting in a difference of 35 g (15 g above the threshold of difference for this particular chronic disease as per industry standards), an alert will be displayed as a precautionary mechanism for the user to double check the actual nutritional value of the food item.

The guess functionality may also be used for educational purposes. For example, an alert may be generated prompting the user to review their guess. With repetition, the user will eventually be able to improve their ability to accurately estimate their food intake consumption. These alerts will also be available to clinicians and dietitians to address the areas of improvement required when preparing educational materials for such patients. Furthermore, this features may also be used for gamification to increase user engagement. For example, a user may compete with other registered users whereby badges are provided to users who accurately guess their food consumption. The user with the most number of badges may receive some form of prize or notice that is sent to the user's connections through their social network account in a social networking service such as Facebook.

In an alternative embodiment, food input means may receive a scan of a barcode or other machine readable code on the food's packaging. At 420D, the user of the user device provides a scan of a bar code associated with the food item to be consumed. The bar code may be a universal product code (UPC). Preferably, the barcode is a nonpredictable barcode that provides information for automatically linking the food input means to a food item stored in a remote computer. The nonpredictable bar code can encode an electronic address of the remote computer such as a Uniform Resource Location (URL), a Uniform Resource Name (URN) or an Internet Procotol (IP) address. The first portion of the electronic address can be fixed and predictable while the second portion of the electronic address is nonpredictable. When concatenated, the barcode information identifies the remote computer and the location where the corresponding food item may be retrieved. The bar code may be on the food's packaging, on a menu, on a store display sign or in proximity to food at the point of food sale. In an alternative embodiment, the food item can also be identified by machine recognition of the bar code label. For example, nutrient density can be determined by receipt of wirelessly transmitted information from a remote sources such as a grocery store display, restaurant menu or vending machine. Food density can also be estimated by processing an image of the food item itself or through manual input received from the user of the user device.

The mobile device may be equipped with several digital sensors including GPS whereby it is possible to embed metadata descriptors into the generated image or voice command where such metadata includes the user's activity, location, time, date and physiological conditions at the time when the image was taken.

At 430, the obtained indicator, which may be in the form of an image, voice, text or barcode format, is processed by the processor on the user device 110 to generate a string of food parameters. The food parameters may comprise of specific ingredients or nutrients, and descriptors such as its color, texture, shape, size, quantity and measurements. At 440, the food parameters are processed by the processor 210 to automatically identify the one or more food items. One or more processes may be used by the processor 210 to automatically identify the food items from the string of food parameters.

At 440A, the processing unit 210 makes use of a machine learning algorithm, which may be based upon pattern matching, to determine the food items associated with the string of food parameters. Algorithms include neural network, fuzzy logic and Bayesian based algorithms. The food parameters may comprise of textual data that represents information extracted from the food indicator. An exemplary algorithm compares the input food parameters with parameter inputs from the user's history or other records in an existing database to determine the food items that correspond with the parameters.

At 440B, the processing unit 210 determines if the food parameters are associated with a food item that already exists in a database 130. For example, the parameters may be associated with specific food items in a database 130 that links food items with such parameters for food identification.

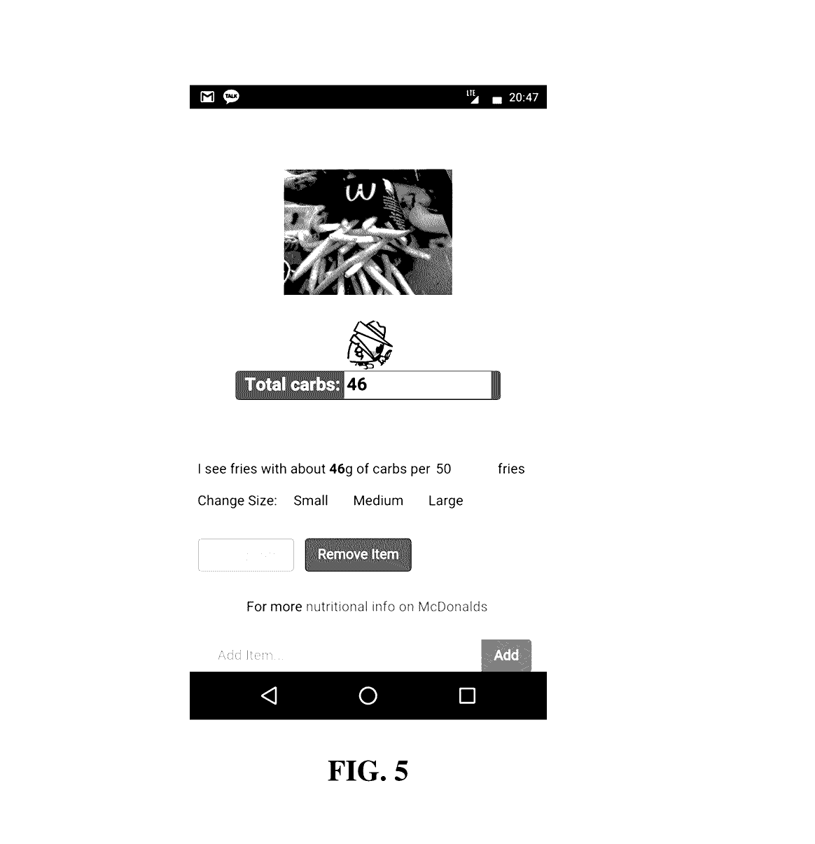

At 440C, the processing unit 210 determines if the parameters are associated with a food item that is a simple item such as an apple or a complex food item such as a burger. If the parameters are associated with a simple food item then the relevant nutrient data may be retrieved from nutritional databases such as the USDA (US Department of Agriculture) database. Such data includes the standard serving size as per guidelines and the necessary sizing options for each item. As illustrated in FIG. 5, for simple food items, the processing unit may alternatively prompt the user device for further input to help provide a more accurate result for the user. The prompt may include requesting the user to verify the accuracy of the result and the size of the food item.

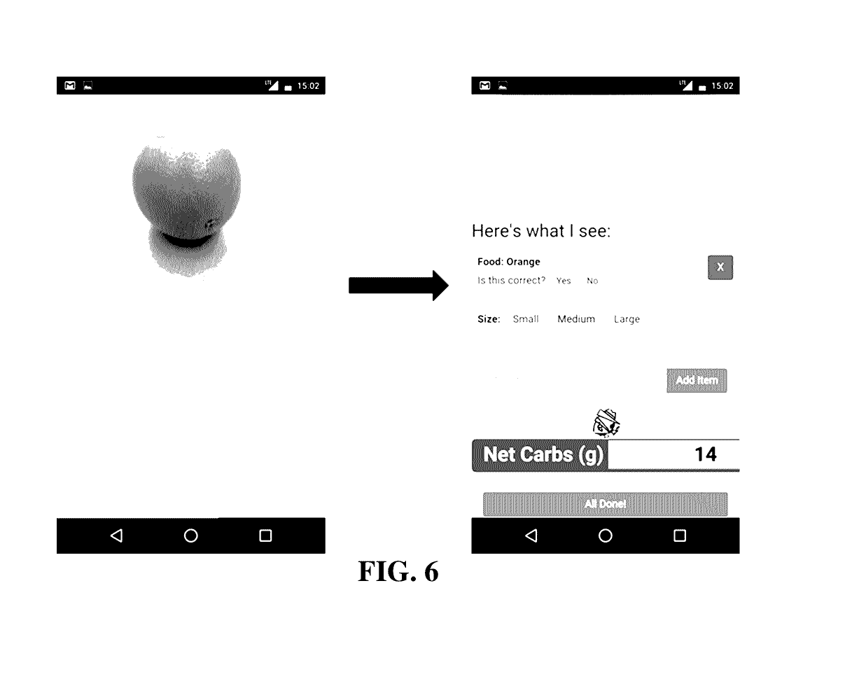

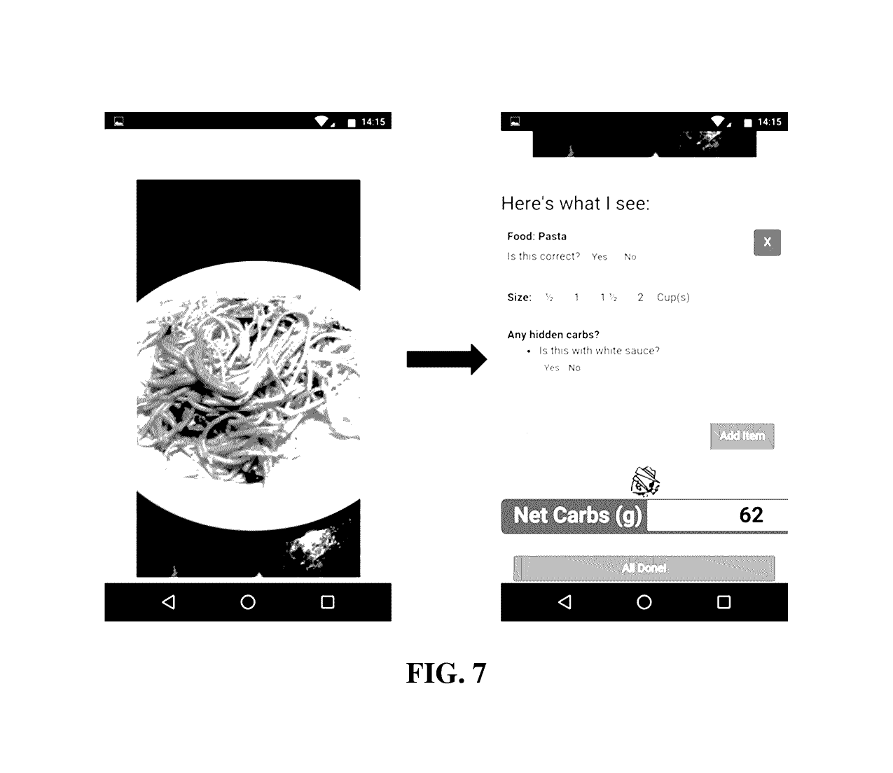

If the parameters are associated with a complex food item, the processing unit 210 may identify all the simple food items composed in the complex food item and calculate the total sum nutrient value for that complex food item. For example, a complex item such as a burger can be decomposed into simple food items such as lettuce, tomato, beef patty and bun. As illustrated in FIG. 6 and FIG. 7, for complex food items, the processing unit may alternatively prompt the user device for further input to help provide a more accurate result for the user. The prompt may include requesting the user to select from a list of pre-populated food items as described in 420C.

At 450, the processing unit 210 determines the food items and the caloric intake for the corresponding food item without any further processing or user intervention. The automated identification of food items, its associated parameters and food indicators are then stored either locally on the device or on a remote storage location accessible by the user. The processing unit may also determine a cumulative amount of a type of food which the user has consumed during a period of time.

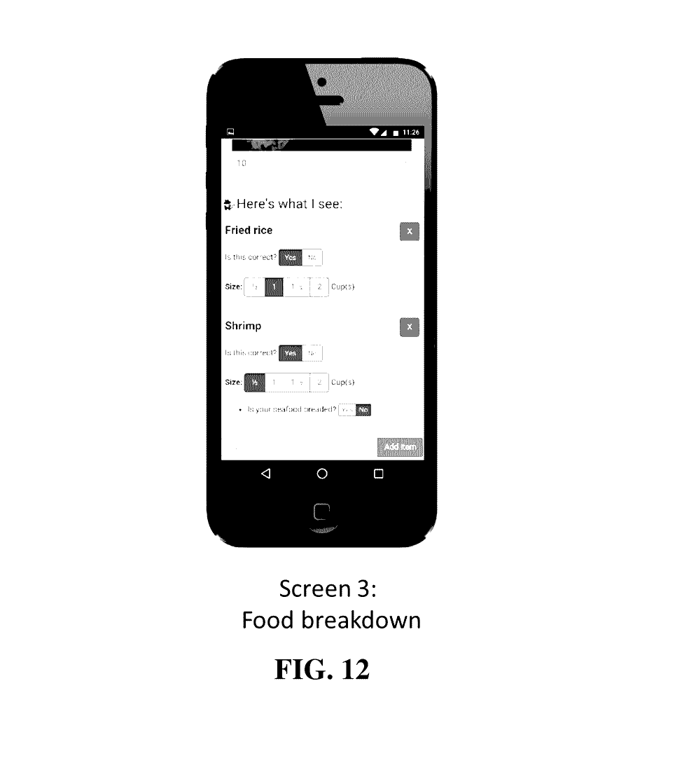

At 460, the food item and calorie intake information will be displayed at the user device. FIG. 12 and FIG. 13 are exemplary displays at the graphical user interface of the user device of a detected food item. The user device may also provide feedback based upon the food items identified. As illustrated in FIG. 7, feedback may allow the user to change the size of the food item and verify the accuracy of the results. Feedback may also include warnings based on user's needs, general nutrition information, food consumption tracking and social interactions. The user device 110 can sound an alarm to a person when the cumulative consumed amount of a selected type of food exceed an allowable amount. The target amount of consumption can be based upon recommendations by a health care professional or governmental agency using variables such as the person's gender, weight, health conditions, exercise patterns, health goals. The user's clinician can also be alerted through periodic reports for added benefit and learning when he/she goes back to see their physician and dietitian. Third parties and user history may also be utilized to provide accurate and customized feedback for a user. Third party food providers can present specific nutritional information on products to a user. User health can be tracked, for consumption concerns and warnings provided to a user when issues arise.

In an alternative embodiment, the indicator of the food may be transmitted from the user device 110 to a remote location where automatic food identification occurs and the results can be transmitted back to the device. Identification of the quantities of food, ingredients or nutrients that a person consumes from pictures of food can be a combination of automated identification food methods and human based food identification methods.

In an alternative embodiment, automated food item identification can be performed by analyzing one or more pictures of the food. Volume estimation can include the use of a physical or virtual marker or object of known size for estimating the size of a portion of food. The marker can be a plate, utensil or other physical place setting member of known size. A marker may be used in conjunction with a distance finding mechanism that determines the distance from the camera and the food. Alternatively, pictures of food from multiple perspectives can be used to create a volumetric model of the food in order to estimate food volume. Such methods can be used prior to food consumption and again after food consumption. Multiple pictures of food from different angles can enable three dimensional modeling of food volume. Multiple pictures of food at different times can enable estimation of the amount of food that is actually consumed vs just being served in proximity to the person.

While the invention has been shown and described with reference to a particular embodiment thereof, it will be understood to those skilled in the art, that various changes in form and details may be made therein without departing from the spirit and scope of the invention.

1. A method of providing a food tracking service for tracking consumption of one or more food items, the method comprising:
receiving an authentication request from a user device wherein the request includes user credentials provided by a user through a graphical user interface of the user device that receives input from the user and displays output;
processing the authentication request to determine if the user is a registered user authorized to access the food tracking service;
receiving from a food input means an indicator of one or more food items to be consumed;
extracting the obtained indicator to generate a string of food parameters;
processing the food parameters to identify the one or more food items associated with the food parameters and its corresponding nutritional information; and
transmitting the one or more identified food items and corresponding nutritional information to the user device wherein the identified foot items and nutritional information are displayed on the graphical user interface.

2. A method of claim 1, wherein the graphical user interface of the user device allows the user to refine the food description.

3. A method of claim 1, the method further comprising transmitting feedback wherein the feedback comprises of warning prompts using pre-set rules based on one or more of: pre-set goals, general nutritional information, food consumption and social interactions.

4. A method of claim 1, wherein the feedback includes an alarm that can sound in the user's device when a cumulative amount of a selected type of food exceeds an allowable amount.

5. A method of claim 1, wherein the food input means is an image taking application associated with the user device's camera.

6. A method of claim 1, wherein the indicator is one or more images of the food item to be consumed by the user.

7. A method of claim 1, wherein the indicator is two or more images of the food item wherein the images are from two or more perspectives to create a multi-dimensional modeling of food volume.

8. A method of claim 1, wherein the indicator includes the use of physical or virtual markers of known size for estimating the size of a portion of the food item wherein the marker can be one of a plate, utensil or other physical place setting member of known size.

9. A method of claim 1, wherein the indicator is a non-predictable barcode on the food item's packaging.

10. A method of claim 1, wherein the camera has a variable focal length and automatically adjusted to focus on the food item.

11. A method of claim 1, wherein the food input means is a voice receiving application associated with the user device's microphone.

12. A method of claim 1, wherein the indicator is a verbal description of the food item to be consumed.

13. A method of claim 1, wherein the food parameters include one of at least the following parameters: color, texture, shape and size.

14. A method of claim 1, wherein the user's device is equipped with GPS functionality and able to embed metadata descriptions into the generated image or voice command.

15. A method of claim 1, wherein the food parameters are applied to a pattern matching algorithm to identify the food items associated with the string of food parameters.

16. A method of claim 1, wherein the food parameters are matched against data in a database to identify the one or more food items associated with the food parameters.

17. A method of providing a food tracking service for tracking consumption of one or more food items, the method comprising:
transmitting authentication credentials to a remote source to determine whether the user is a registered user authorized to access the food tracking service;
producing an indicator of one or more food items wherein the indicator comprises one or more photos of the one or more food items to be consumed and wherein the one or more food items is either a complex food item or a simple food item;
transmitting the indicator to a remote source wherein the remote source is able to determine whether the one or more food item is a simple food item or a complex food item and if the food item is a complex food item then the remote source identifies all the simple food items composed in the complex food item;
receiving a calculated sum of nutrient value for the one or more food item; and
displaying the nutrient value.

18. A system for monitoring food consumption comprising
a food input means running on a user device for obtaining an indicator of one or more food items to be consumed; and
a processing unit for extracting a string of food parameters from the indicator and analyzing the food parameters to identify one or more food items associated with the food parameters and estimate the types and amounts of food, ingredients, nutrients and calories that are associated with the one or more food items.

19. A system of claim 18, wherein the indicator comprises one or more of pictures of the food item wherein the pictures may be taken at different times and different angles.

20. The system of claim 18, wherein the food parameters are selected from a group consisting of: a specific type of carbohydrate, a specific type of sugar, a specific type of fat, a specific type of cholesterol, a specific type of fiber, a specific type of protein, a specific sodium compound.
